(19) United States
(12) Patent Application Publication
(10) Pub. No.: US 2026/0212690 A1
(43) Pub. Date: Jul. 23, 2026

(54) QUANTITATIVE PARTICLE CONTENT ASSESSMENT USING HYDRATED STATE IMAGING AND IMAGE ANALYSIS

(71) Applicant: INTELLIGENT VIRUS IMAGING INC., Southern Pines, NC (US)

(72) Inventors: Rickard Nordström, Tullinge (SE); Taeyang Jung, Stockholm (SE); Thomas Bausewein, Solna (SE); Jan Fulin, Järfälla (SE); Ida-Maria Sintorn, Sollentuna (SE)

(21) Appl. No.: 19/139,960

(22) PCT Filed: Dec. 15, 2023
(86) PCT No.: PCT/US2023/084166

§ 371 Date: Jun. 17, 2025

Related U.S. Application Data
(60) Provisional application No. 63/434,113, filed on Dec. 21, 2022.

(51) Int. Cl. G06V 20/69; G01N 15/1433

(52) U.S. Cl. CPC G06V 20/698; G01N 15/1433; G06V 2201/04

(57) ABSTRACT

The present invention relates to a method for establishing a correlation between sizes of genetic material contained in virus, virus-like particles (VLPs) or bacteriophages and the measured particle interior intensities of the particles using hydrated state imaging to quantitatively describe, separate and classify the particle populations. The method further comprises the step of graphically displaying the distribution of the particle interior intensities for each reference sample relative to sizes of the genetic material in each reference sample.

### TECHNICAL FIELD

The present invention relates to a method for establishing a correlation between sizes of genetic material contained in virus, virus-like particles (VLPs) or bacteriophages and the measured particle interior intensities of the particles using hydrated state imaging to quantitatively describe, separate and classify the particle populations.

### BACKGROUND AND SUMMARY OF THE INVENTION

In the pharmaceutical industry, Virus-Like Particles (VLPs) or viruses, for example, Adeno Associated Virus (AAV) particles and bacteriophages are extensively used as a carrier for gene delivery. In general, VLPs or replication deficient AAVs cannot replicate/reproduce as opposed to real virus particles and are often preferred as a carrier for gene delivery. The assessment of the amount of content, i.e., the length of the genetic material is of prime importance for quality control as it is directly linked to the safety and efficiency of the treatment.

Different methods have been suggested to assess the amount of content such as the length of the packaged genome of virus particles, Virus-Like Particles (VLPs) and AAV particles. One indirect method is real-time polymerase chain reaction, also known as the quantitative polymerase chain reaction (qPCR). While qPCR is extensively used across the gene therapy industry, the method requires pure samples, and the assay variability is negatively impacted by different buffer matrices and impurities. Another indirect method is the analytical ultra-centrifugation (UAC), where particles of different sedimentation coefficients, i.e., densities (different amount of content such as different lengths of the genetic material packaged in AAVs), elute at different times. One drawback of this method is that it requires large amounts of the sample. Moreover, the AUC can only provide information on population scale and cannot provide information about the genomic content of individual particles.

For crude (filled/empty) assessment of the content of AAVs and VLPs, negative-stain Transmission Electron Microscopy (nsTEM) has also been suggested. nsTEM is fast, simple and provides a good resolution so the VLP and AAV particles can actually be seen (which is why it is called a “direct” method). However, it was recently discovered that nsTEM has inherent characteristics that makes it is unreliable, not robust, and even erroneous when it comes to assessing even crudely (empty or filled) the content of VLPs, AAV particles and real virus particles. The stain might adversely affect the morphology of the sample and particles and the preparation process might create local variation and induce morphological effects. The stain does not always enter empty intact particles, giving rise to false full particles, and sometimes stain accumulate on top of a (full or empty) particle making it look empty creating false empty particles.

In other words, in both research and production setups, there is a need for a reliable way to assess the size of genetic material that gets packed into drug delivery particles such as VLPs, AAVs and real viruses with good robustness, accuracy, repeatability and specificity at the sample level. This to ensure efficacy and quality of the therapeutical product as well as to optimize formulation and production steps.

There is a need for a way to quantify the size of genetic material contained in delivery particles. An incorrect length of the genetic material may be an indicator that the delivery particles have incorporated host cell genetic material or a truncated gene/genome, possibly giving adverse therapeutical effects. The present invention is a reliable approach by which to establish a quantitative relationship between the intensity of the particles' interiors as measured in images and the size of the genetic material packed of a certain type into a type of delivery particle, and to use the same established relationship to estimate the size of packed genetic material of the same type in the same type of delivery particles in novel samples. The present invention can determine the genome length both for individual particles and populations of particles.

More particularly, the method is for quantitative assessment of the size (length) of genetic material packed into VLPs, AAVs, real virus particles and bacteriophages by imaging them in their native hydrated state by using e.g., Cryo Transmission Electron Microscopy (CryoTEM) followed by image processing for particle detection, uneven background correction, intensity normalization and quantitative measurement of the intensity of the particles' interiors in the acquired images. It was surprisingly discovered that the intensity of particle interiors as measured in carefully normalized images closely correlates to the amount of content of the particle, for example to the length of the DNA packed into an AAV delivery particle. The analysis can be done by imaging the sample in ionic liquid TEM or using special sample holders for liquid samples (sometimes referred to as liquid TEM or in situ TEM). The ionic liquid method is similar to CryoTEM in that the addition of the ionic liquid keeps the particles in a hydrated state so there is no need to use stain to enhance the contrast.

The method of the present invention is for establishing a correlation between measured interior intensities of the particles using hydrated state imaging and the size of the genetic materials contained in virus or virus-like particles (VLPs). Providing a first reference sample of virus or virus-like particles (VLPs) containing a first genetic material having a known first size, a second reference sample of virus or virus-like particles (VLPs) containing a second genetic material having a known second size, a third reference sample of virus or virus-like particles (VLP) containing a third genetic material having a known third size, the first size being different from the second size and the second size being different from the third size;
imaging the first, second and third samples using a hydrated state imaging technique;
measuring a particle interior intensity of each virus particle or VLP in images of each reference sample;
determining a distribution of particle interior intensities of the virus particles or VLPs in each reference sample;
determining a distribution of the particle interior intensities for each reference sample relative to sizes of the genetic material in each reference sample;
fitting a curve to the distributions of the first, second and third reference samples, correlating the measured interior intensities and each respective known genetic size;
the fitted curve describing a relation between interior particle intensity and size of genetic cargo.

The method further comprises connecting two or all three of the first, second and third distributions to form a straight line.

The established correlation is used to determine a genome length of a sample with a cargo of genetic material of unknown length.

The method further comprises the step of graphically displaying the distribution of the particle interior intensities for each reference sample relative to sizes of the genetic material in each reference sample.

The method further comprises the step of estimating a peak of the histogram for which a peak intensity of each reference sample represents a most common interior intensity value of particles in each reference sample and connecting the displayed distributions of each reference sample, based on the peak intensities of each reference sample, as a straight line.

The method further comprises the step of taking images of the reference samples and normalizing the images.

The method further comprises the step of normalizing background and particle shell shade.

An average intensity of background pixels and an average intensity of particle shell pixels in an image corrected for uneven background are used as reference values for the normalization.

The measured particle interior intensities are normalized locally based on each particle's shell intensity and an intensity of the local background surrounding the particle excluding a closest background region corresponding to a bright defocus ring.

The method further comprises the step of measuring particle interior intensities of adeno associated virus (AAV) particles.

The method further comprises a comparison between multiple populations of interior intensities.

The hydrated state imaging technique used is cryoTEM comprising of freezing and imaging the samples at a cryogenic temperature.

The hydrated state imaging technique used comprises adding an ionic liquid to the sample to keep the particle in a hydrated state followed by room temperature TEM.

The hydrated state imaging technique used comprises using a liquid sample holder to keep the samples in liquid form and imaging the samples in room temperature TEM.

The method further comprises the step of measuring particle interior intensities of bacteriophages.

The method further comprises the step of particle interior intensities of AAV particles of different serotypes.

### BRIEF DESCRIPTION OF THE DRAWINGS

FIG. 1 is a schematic view of a typical image (one view) of an AAV sample imaged with cryoTEM that has a slightly darker background towards the right side of the image. That is, the image has uneven background.

FIG. 2 is a schematic view of an illumination corrected (background corrected) view of FIG. 1.

FIG. 3 is a schematic view that shows the result of automatic circular particle detection applied to FIG. 2 wherein the white disks correspond to automatically detected particles.

FIG. 4 is the same view as in FIG. 3, but where the black disks corresponding to the detected particles in FIG. 3 are overlayed on the original image.

FIG. 5 is a schematic view wherein the particle masks in FIG. 3 are shrunk (eroded) to correspond to the interiors of the particles.

FIG. 6 is the same view as in FIG. 5, but the shrunk particle masks are instead displayed in black and overlayed on the original image.

FIG. 7 is a schematic view of a binary mask, where the white rings correspond to the particle shells, derived by subtracting the shrunk particle mask in FIG. 5 from the original particle mask in FIG. 3.

FIG. 8 is the same view as in FIG. 7, but the particle shell masks are displayed in black and overlayed on the original image.

FIG. 9 is a binary image corresponding to the expanded (dilated) particles' masks in FIG. 3.

FIG. 10 is the same view as in FIG. 9 but the expanded particles' mask is shown in black and overlayed on the original image.

FIG. 11 is a view of the binary mask of the complement of the expanded particles' mask in FIG. 9 which corresponds to the background mask.

FIG. 12 is the same view as in FIG. 11 but the background mask is displayed in black and overlayed on the original image.

FIG. 13 is a view of the illumination corrected image in FIG. 2, normalized to intensity values covered by the particle shell mask (shown in FIG. 7), and background mask, respectively.

FIG. 14A is a graphical view of histograms (distributions) of interior intensities of particles from 5 different samples with known lengths of the packed genetic content.

FIG. 14B is a graphical view that shows the distributions and peaks of the number of particles in the 5 samples illustrated in FIG. 14A.

FIG. 15A is a graphical view of the intensity distributions of the particles in the five samples plotted against their known genetic size wherein a straight line is fitted to the distribution that shows a linear relationship between measured intensity and length of the packed genetic material.

FIG. 15B is a graphical view of the intensity distributions of the particles in the five samples plotted against their known genetic size wherein a curved line (polynomial) is fitted to the distribution that shows a relationship between measured intensity and length of the packed genetic material.

FIG. 16A is a schematic view of an image of a first reference sample with uneven background intensity and three particles packed with a genetic material of a first size.

FIG. 16B is a schematic view, the same view as FIG. 16A, but where the uneven background has been corrected so the whole background has a same intensity level.

FIG. 17A is a schematic view of an image of a second reference sample with uneven background intensity and three particles packed with a genetic material of a second size smaller than that of the first reference sample in FIGS. 16A-B.

FIG. 17B is a schematic view that is the same view as illustrated in FIG. 17A but where the uneven background has been corrected so the whole background has a same intensity level.

FIG. 17C is a schematic view that is the same as FIG. 17B but illustrating that the intensities have been normalized to FIG. 16 B so that the mean background intensities in FIG. 17C and FIG. 16B are equal, as are the mean intensity levels of the particle shells.

FIG. 18 is a schematic view that illustrates five reference samples, each with three particles packed with genetic material of different size for each sample. Each image has been corrected for uneven background and intensity normalized so all images have equal mean background intensity and equal mean particle shell intensity.

### DETAILED DESCRIPTION

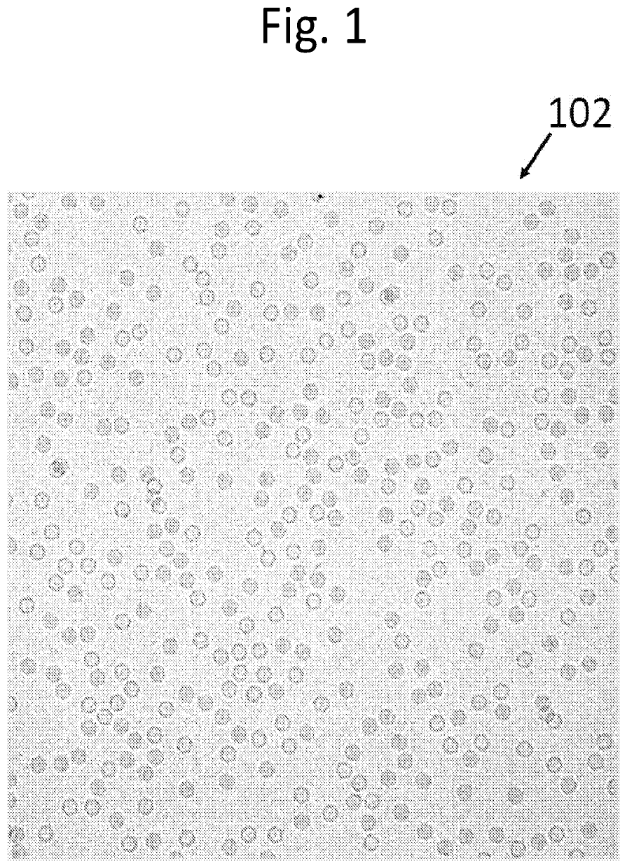

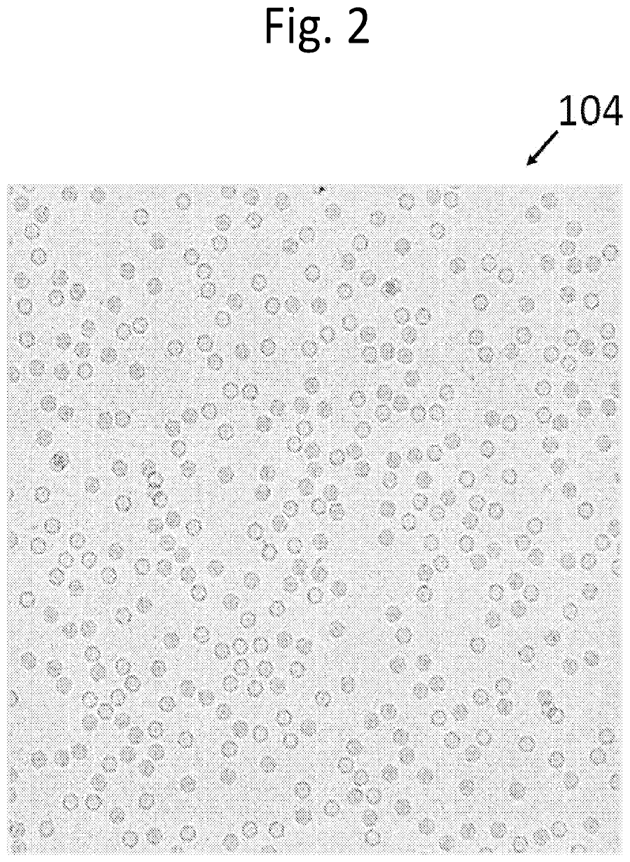

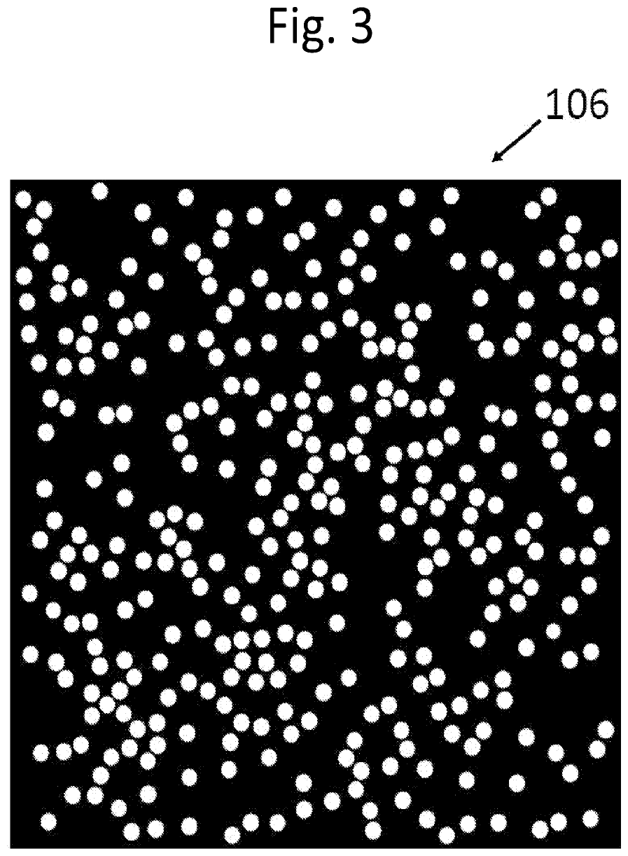

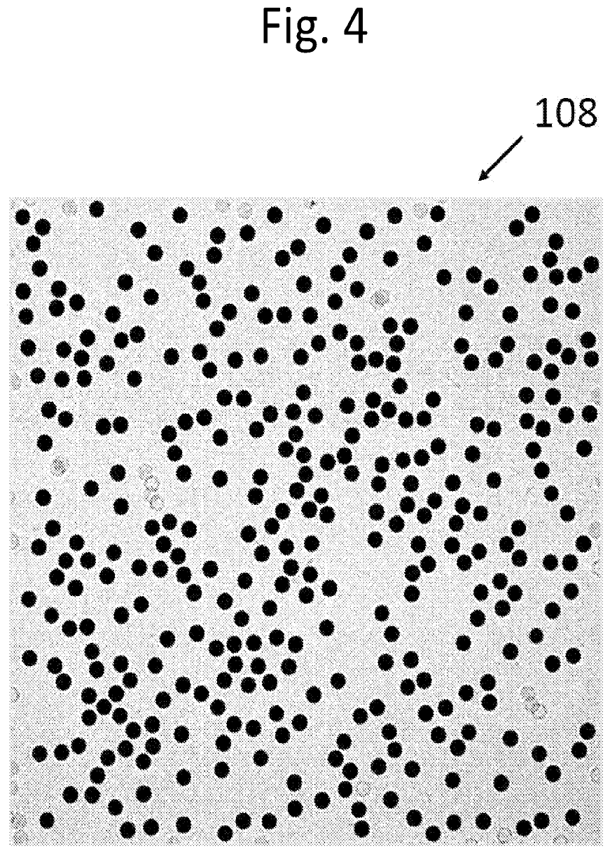

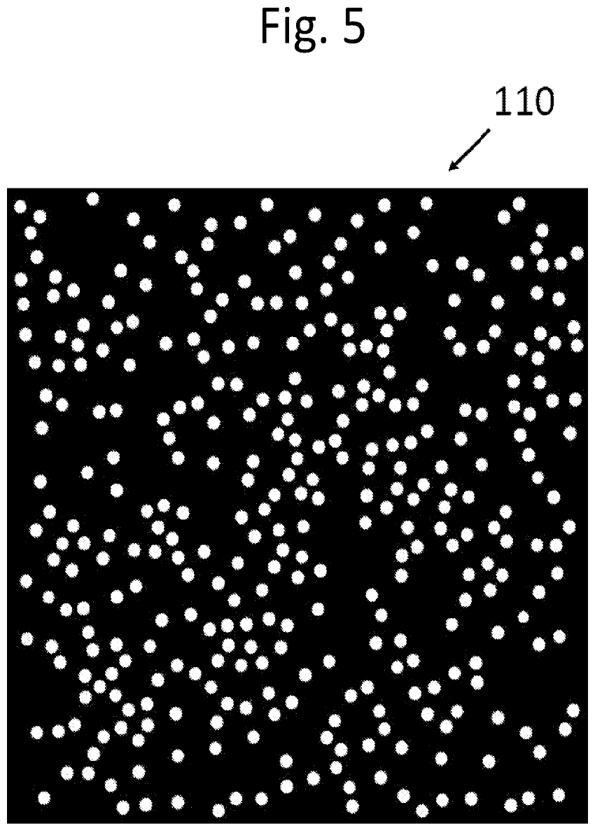

FIG. 1 is a schematic view 102 of a typical image (one view) of an AAV sample imaged with cryoTEM that has a slightly darker background towards the right side of the image. FIG. 2 is a schematic view 104 of an illumination (background) corrected view of FIG. 1. FIG. 3 is a schematic view 106 that shows the result of automatic circular particle detection applied to FIG. 2 wherein the white disks correspond to automatically detected particles. FIG. 4 is a schematic view 108 which is the same view as in FIG. 3, but where the black disks corresponding to the detected particles in FIG. 3 are overlayed on the original image. FIG. 5 is a schematic view 110 wherein the particle masks in FIG. 3 are shrunk (eroded) to correspond to the interiors of the particles.

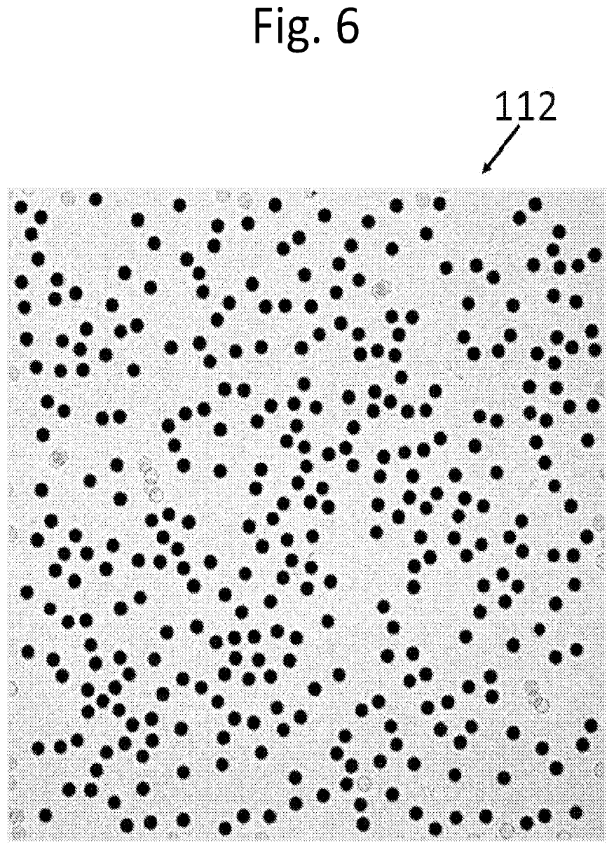

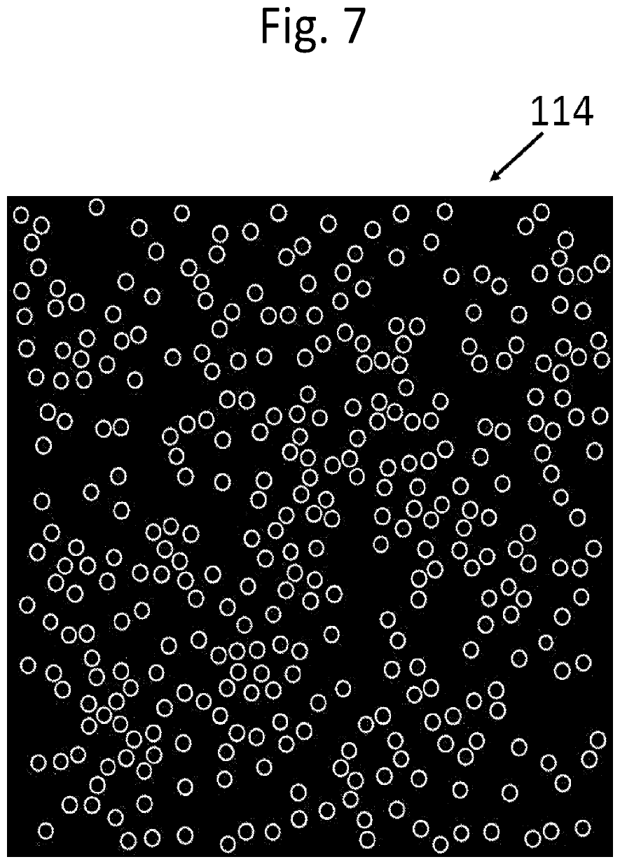

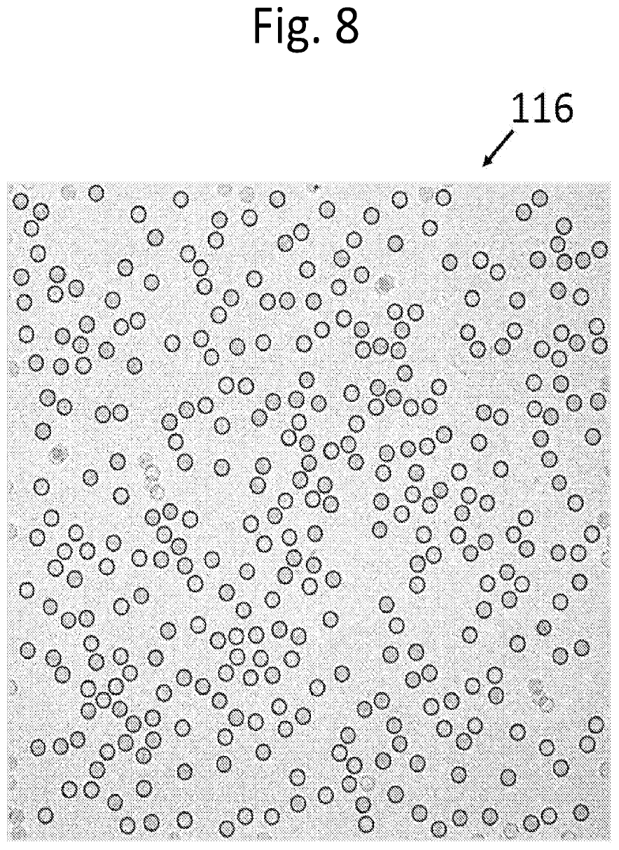

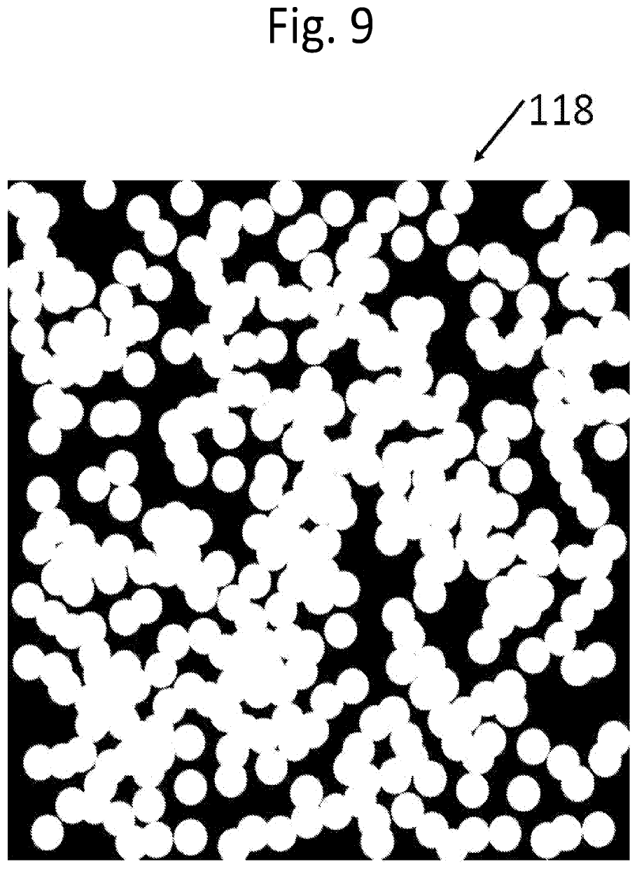

FIG. 6 is a schematic view 112 which is the same view as in FIG. 3, but the shrunk particle masks are instead displayed in black and overlayed on the original image. FIG. 7 is a schematic view 114 of a binary mask, where the white rings correspond to the particle shells, derived by subtracting the shrunk particle mask in FIG. 5 from the original particle mask in FIG. 3. FIG. 8 is a schematic view 116 which is the same view as in FIG. 7, but the particle shell masks are displayed in black and overlayed on the original image. FIG. 9 is a binary image 118 corresponding to the expanded (dilated) particle masks shown in FIG. 3.

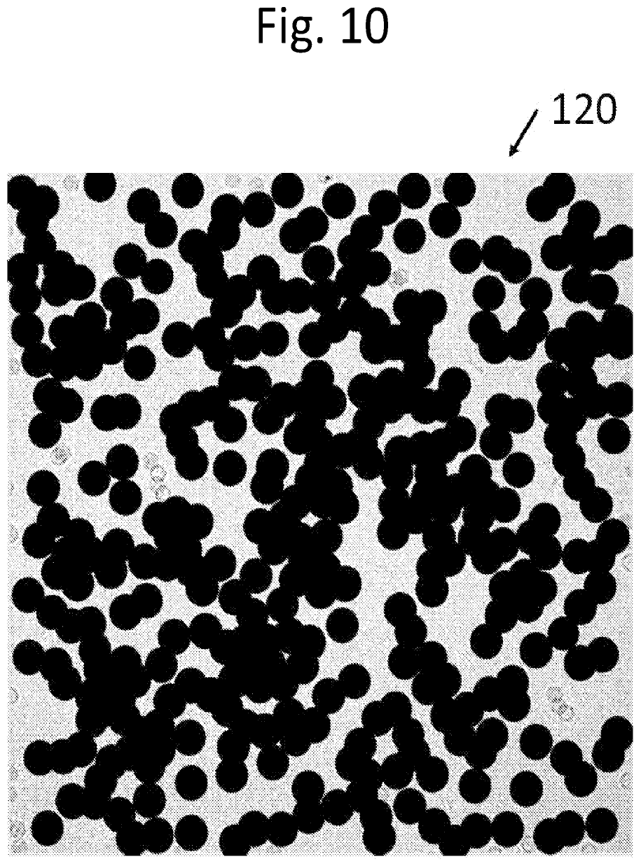

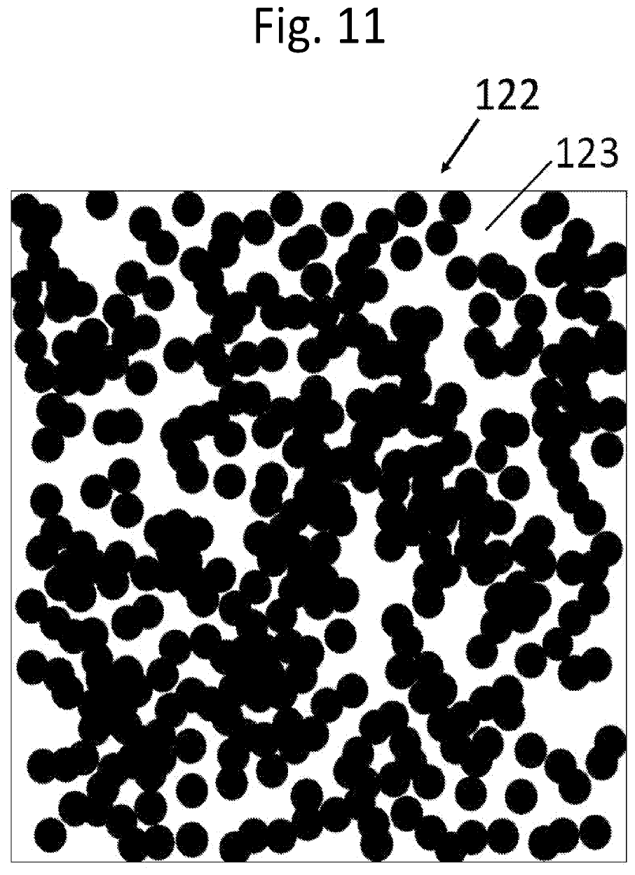

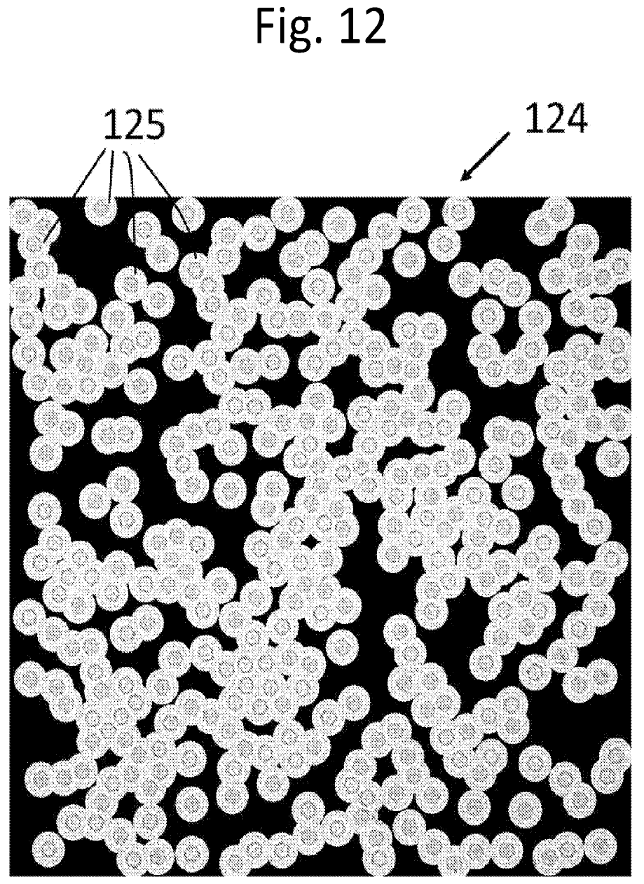

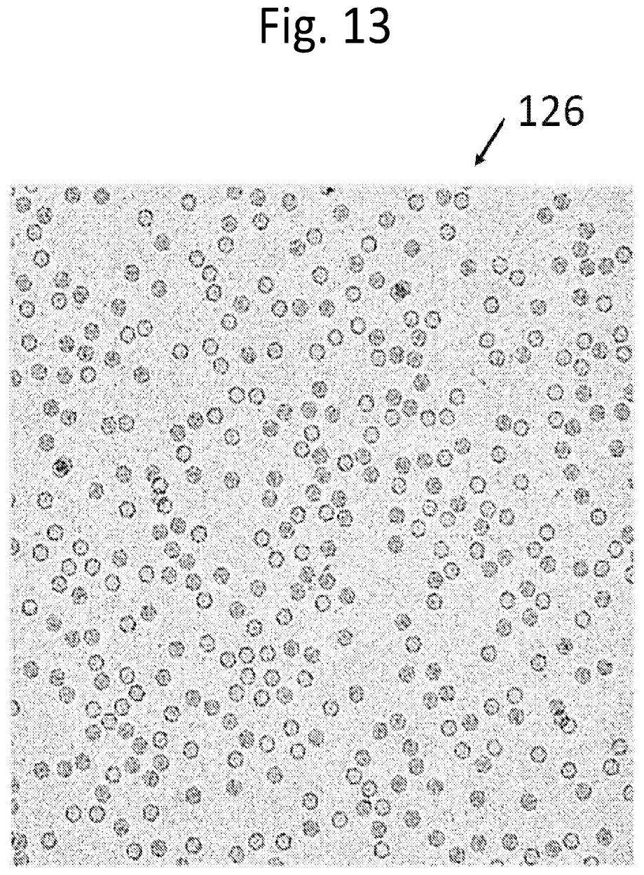

FIG. 10 is a schematic view 120 which is the same view as in FIG. 9, but the expanded particle mask is shown in black and overlayed on the original image. FIG. 11 is a schematic view 122 of the binary mask of the supplement of the expanded particles' mask in FIG. 9 which corresponds to the background mask. FIG. 12 is a schematic view 124 which is the same view as in FIG. 11, but the background mask is displayed in black and overlayed on the original image. FIG. 13 is a schematic view 126 of the background corrected image in FIG. 2, normalized to intensity values derived from the particle shell mask (shown in FIG. 7), and background mask, respectively.

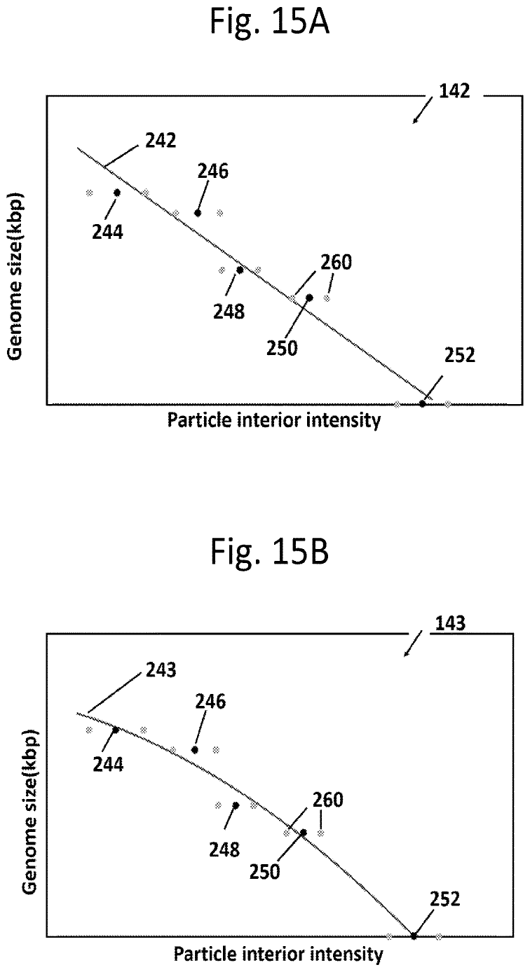

The present invention is for the quantitative measurement of the particle content of particles using a hydrated state imaging method such as CryoTEM followed by image processing that consists of the following main steps for a provided sample of bacteriophages, virus or virus-like particles (VLPs), such as AAV particles:
1) For CryoTEM, the sample is rapidly frozen at a cryogenic temperature;
2) While at the cryogenic temperature, images are acquired, by using a digital camera in an imaging device such as an electron microscope, of the frozen sample in the CryoTEM imaging device at a magnification and resolution where individual particles and their interior can clearly be distinguished and observed. For other hydrated state imaging methods, the imaging is not in a TEM imaging device at cryogenic temperatures, but instead disposed in liquid form by using liquid sample holders for room temperature TEM imaging, or by adding an ionic liquid to the sample to preserve its liquid characteristics in a solid state followed by room temperature TEM imaging; and
3) An amount of each particle's content is determined in the acquired images by a computational device.
   To determine the content of each particle robustly the image needs to be corrected for uneven illumination and intensity normalized based on preserved particle and image features prior to quantitively measuring the intensity of the particles' interiors. This is done in a computational device for example via the following steps:
   a) Correct the acquired images for uneven illumination;
   b) Detect and mark the particle shells in the image, i.e., create a particle shell mask;
   c) Detect and mark the background (non-particle) parts of the image, i.e., create a background mask;
   d) Normalize the intensity range in the image based on the pixel intensity values in the particle shells and the background, i.e., preserved particle and image features, to the predefined values A & B; and
   e) Measure the intensity of the interior of each particle in the normalized image. This intensity corresponds to the length of the packed genetic material or other content via a transformation (fitted curve) determined from samples with known sizes or lengths of packed genetic material processed in the same way as described above.
   f) Correct the internal intensity of each particle by using the particle's shell intensity or by local normalization.
4) The internal densities of all detected particles in the sample are grouped into populations. These populations are either classified based on internal intensity (e.g., low internal intensity, intermediate internal intensity, high internal intensity) or correlated to reference values of known genetic material. A ratio between these populations can be calculated.
   Establishing the internal particle intensity and size of genetic material correlation:
   Multiple samples of AAVs each packed with genetic material of known lengths; 11=no genome, 12, . . . , In, where (n) is the number of different samples, are prepared and imaged using CryoTEM. It should be understood that any bacteriophage, virus particle or virus-like particles may be used, and that the invention is not limited to AAV particles or a specific serotype. AAV is merely used as an illustrative example and the same principles apply to other virus, virus-like particles, bacteriophages, and gene therapy vectors. In a similar manner, genetic material is used as a generic example, the correlation should be established for the specific type of genetic material and type of particle to be analyzed. Types of genetic material can for example be single and double stranded DNA or RNA and hairpin or other secondary structures. Correction of uneven illumination is then performed separately on all images, whereafter AAV particles are automatically detected by applying automated particle detection and if needed followed by manual curation (removal of false detections and manual adding of missed particles).
   For each image, a mask corresponding to all particle shells (see FIG. 7) is created by subtracting the union of shrunk versions of all particle masks (see FIG. 5) from the union of all original particle masks (see FIG. 3).
   Also, for each image, a background mask is created as the complement of the union of and expanded version of the union of all particle masks (white region 123 in FIG. 11). It should be noted that the particle masks are expanded to cover the bright ring 125 surrounding each particle originating from the defocus setting used when imaging (as shown in FIG. 12). Each image is then normalized (linearly stretched) so the median (or mean or another statistical measure) of all intensity values covered by the particle shell mask is set to intensity level A and the median (or other statistical measure) of all intensity values covered by the background mask is set to intensity level B. The normalized image is displayed in FIG. 13. It should be noted that using the median (50 percentile) or lower percentile when deriving intensity normalization level A makes the approach robust for particle detections that do not fit exactly to the particle contours. AAVs, for example, appear as hexagons in the image depending on the 3D rotation. So, if the detection is performed by fitting a circle to the exterior of the particle, the circle contains a portion of background pixels. By using a low percentile these non-particle shell pixels are disregarded when deriving normalization intensity level A.
   Next, the interior intensity for each particle is measured as the median (other statistical measures such as the mean would also work or e.g., the 20^{th} percentile) of the central pixels under each particle's shrunk particle mask. Each sample is then represented by the distribution of all its particles' interior intensities. It was surprisingly noticed that the distribution (e.g., the peak of a fitted gaussian) of interior intensities in a sample correlate well with the amount of the packed content, which for AAVs typically would be the length of the cargo genetic material such as DNA. Again, the AAVs are here merely used as an illustrative example and the principles of the present invention also apply to other virus, virus-like particles, and gene therapy vectors.
   The correlation of the measured particle interior intensity and the amount of content, size or length of the genetic materials in the virus or virus-like particles of the reference samples can be used to determine the content, size or length of the genetic material of the virus or virus-like particles in an unknown sample by simply measuring the particle interior intensity of the virus or virus-like particles in the unknown sample after it has been background corrected and normalized in the same way as the reference samples.
   Once the relation (linear or smooth curve) between internal intensity and genetic size for a particle type (e.g., AAV) and content type (e.g., length of packed genetic material such as single or double stranded DNA or RNA as well as different conformations e.g., hairpin) has been determined, as described above, this relationship or correlation can be used to estimate the length of the genetic material in a sample of AAVs with a cargo of unknown length. In other words, the user simply uses the measured particle interior intensity and apply this value to the template (depicted in FIGS. 15A-15B) to find the genome size that corresponds to the measured particle interior intensity as determined by either the straight line 242 or curved line 243, as described in more detail below.
   More particularly, the sample of AAVs with a genetic cargo of unknown length is prepared, imaged, and normalized as described above. The peak of the distribution, determined by e.g., smoothing it or fitting a gaussian to it, of the particles' interior intensities as measured in the illumination and intensity normalized image corresponds to the length of the sample's genetic cargo. The width of the distribution peak provides information about the homogeneity in the sample. Multiple peaks indicate that AAV subgroups with different cargo lengths are present in the sample.
   In a different embodiment, the intensity normalization can be performed locally on a per particle basis by using a statistical measure from the pixel intensities of the particle shell (e.g., mean, median or percentile) and a statistical value from the pixel intensities in the particle's immediate or local background region (e.g., mean, median or percentile), after excluding pixels belonging to the defocus ring. Using this local approach makes the first background normalization step described above unnecessary. This local approach is, however, more sensitive to artefacts and noise and requires a sample with well separated particles so that each particle is surrounded by enough local background to allow for determining a robust local background intensity measure.
   In yet another embodiment, the second (brighter) value required for image normalization can be derived from the particle interior of empty particles instead of from background pixels. This, however, assumes that there is at least one empty particle in each image. This approach might be more sensitive to image noise and imaging artefacts as the normalization might depend on only a few particles and then also on a very small number of pixels.

In an alternative embodiment, the method further comprises the step of automatically or manually detecting particles in the images and displaying detected particles on a display and deleting particles that are smaller than a lower size limit and larger than an upper size limit.

In an alternative embodiment, the method further comprises the step of using Cryo Transmission Electron Microscopy to determine the particle content of the VLPs.

In another alternative embodiment, the method further comprises the step of determining the size of genetic cargo in adeno associated virus (AAV) particles of different serotypes.

In yet an alternative embodiment, the method further comprises the step of using the AAV particles as a gene delivery particle.

In another embodiment, the method further comprises adding an ionic liquid to the sample to keep the VLPs in a hydrated state allowing to perform the imaging in an electron microscope operating at room temperature.

In another embodiment, the method further comprises imaging the VLP particles at room temperature in their native, liquid, and hydrated state by using a liquid sample holder.

In another embodiment, the method further comprises using bacteriophages as gene delivery particles.

In an alternative embodiment, the method further comprises the step of quantitatively describing, separating and classifying particle populations of internal intensities.

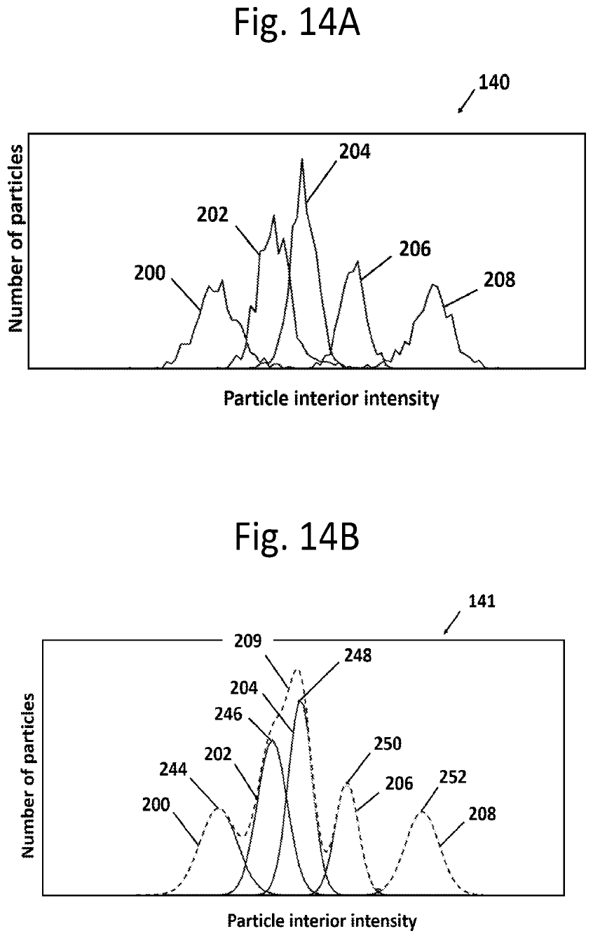

FIG. 14A is a schematic view 140 of histograms (distributions) of interior intensities of particles from 5 different reference samples (first reference sample 200, second reference sample 202, third reference sample 204, fourth reference sample 206, and fifth reference sample 208) with known lengths or sizes of the packed genetic material. The lengths or sizes of the genetic material disposed inside each particle within a sample are substantially similar in these reference samples. The genetic material is often constructed from building blocks so that the length of a certain first genetic material is substantially similar within a first sample while the lengths of another second different genetic material of a second sample is substantially different from the lengths of the first genetic material of the first sample.

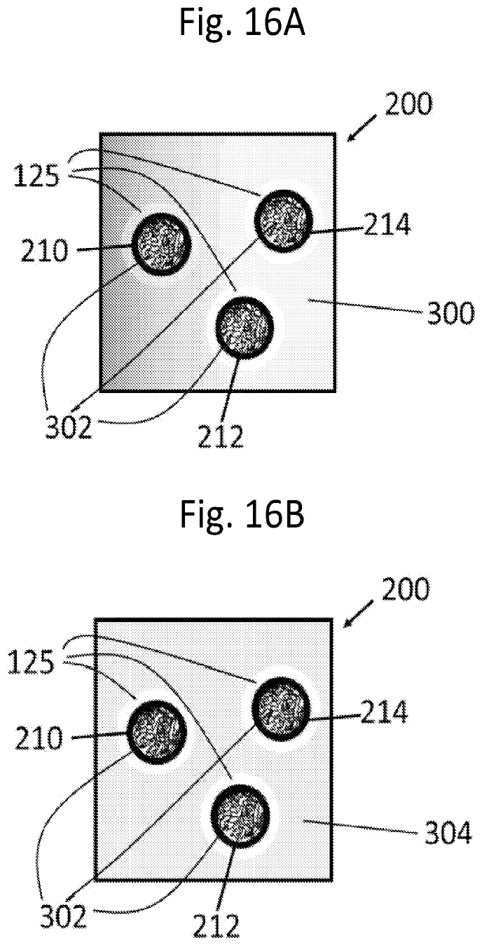

Preferably, the particles 210, 212, 214 of the first reference sample 200 (shown in FIG. 16A) are all same type of virus or virus-like particle such as AAV particles of a specific serotype or any other suitable particle. The correlation between particle interior intensity and size of genetic material cargo needs to be established for a specific particle type and type of genetic material cargo. In other words, when sample 200 contains AAV particles all the other samples contain AAV particles also. The particles 210, 212 and 214 of the first reference sample 200 differ from particles 216, 218, and 220 of the second reference sample 202 in that particles 210, 212 and 214 contain a first size of genetic material 302 while the particles 216, 218 and 220 contain a second size of genetic material 306. Similarly, particles 224, 226, and 228 of the third reference sample 204 contain a third size of genetic material 310, particles 230, 232 and 234 of the fourth reference sample 206 contain a fourth size of genetic material 312, particles 236, 238, and 240 of the fifth reference sample 208 contain a fifth size of genetic material 314. The particles 210 . . . 240 thus differ from one another in that each reference sample 200 . . . 208 contains particles with a different sized genetic material. Each genetic material 302, 306, 310, 312, and 314 has known size and/or dimension such as a known length. In other words, the amount of genetic material in each particle of the reference samples is known. Each size for genetic materials 302, 306, 310, 312, 314 is different so that the first size of the first genetic material 302 is different from all the other sizes of genetic materials 306, 310, 312, 314 and the second size of the second genetic material 306 is different from all the other sizes for genetic materials 302, 310, 312 314 etc.

FIG. 15A is a graphical view 142 of the distributions of the particles in the five reference samples 200 . . . 208 plotted against their known genetic cargo size wherein a line 242 is fitted to the distributions that shows the linear relation between measured interior particle intensity (x-axis) and genetic cargo size or length (y-axis). Preferably, the line 242 represent the best linear fit of the distributions of the measured particle interior intensities of the particles of each reference sample. It was surprisingly discovered that there is a linear or curved relationship between the measured intensity of the particle interiors and the size of the genetic material or genome. The line or curve is fitted to minimize any errors based on the distribution of the measured intensity values i.e., so that all values are as close as possible to the straight line or curve based on equations. More particularly, a curve (polynomial of 1st degree=straight line or 2nd degree for smoothly bent curve fitting) is fitted to the refence samples' internal intensity distributions versus the known genetic cargo sizes.

In this way, it is thus possible to determine the size of the genetic cargo of a sample that contains virus particles with unknown sized genetic material by simply measuring the intensity of the particle interior of the particles in the sample that contains virus particles, such as AAV particles. For example, if it is determined that the interior particle intensity is (I), then the straight line 242 in the graphic view 142 or curved polynomial line 243 in the graphical view 143 of FIG. 15B can be used to determine that the size of genetic cargo of the AAV particles in this sample (S) is (GS). In this way, the views 142, 143 function as a template that can be used to determine the genome size or length of genetic material in a particle by measuring the particle interior intensity of the particle and use the line 242 or curve 243 to determine the size of the genetic material inside the particle as shown on the y-axis. This is very advantageous since it is relatively easy to measure the particle interior intensity of the AAV particles with unknown genetic materials but difficult to measure the size of the genetic material contained in each AAV particle in sample (S).

The more genetic material each particle contains the lower is the measured intensity of the particle interiors in the images, due to that fewer of the electrons in the microscope will penetrate through the interior of each particle in the sample and be detected on the other side of the sample. The fewer electrons that can penetrate through a position of the sample the darker is the image of that position. A gene, genome or genetic material is often described by its size or length. A typical length entity for genetic materials is measured in kilo bases (kb) for single stranded genetic material or kilo base pairs (kbp) for double stranded genetic material.

The reference samples 200 . . . 208 depicted in graph 142 represent a distribution of a large number of virus or virus-like particles such as AAV particles. As indicated above, it was surprising that the distribution between the five samples seems linear as illustrated by line 242. Because the correlation between the interior particle intensity and the genome size is approximately linear, the line 242 in graph 142 may be used as a template for determining the length or size of the genetic material in other samples of AAV particles by simply measuring the intensity of the particle interior of the AAV particles in the sample and translating it to genetic length via the equation describing the reference line 242. This assumes that the AAV particles of the unknown sample only contains AAV particles and that the AAV particles all contain the same type of genetic material.

It turns out that the linear correlation shown in FIG. 15A is quite robust. A smooth polynomial or curved line can alternatively be fitted to the reference sample distributions (curve 243) and that equation can alternatively be used to translate measured interior intensity to the size of genetic material. It may thus be determined that the curve 243, as shown in FIG. 15B, may be a better fit than the line 242 shown in FIG. 15A for certain samples when the error between the measured interior intensities and each respective known genetic sizes is minimized. It should be understood that the line or curve is fitted to all distributions, and line or the curve (i.e., its equation) then describes the relation between interior intensity and genetic cargo size.

In certain situations, the genetic material is quite short and by measuring the interior intensity, it is possible to determine whether the particle contains one or two strands of genetic material. It is important to measure many particles in an unknown sample and when deriving the reference curves in order to obtain correct correlation and it should be noted that there are great variations between each individual particle.

More particularly, the samples shown in FIG. 15A thus represent the distributions of the particle interior intensities of all the particles detected and measured in images of those samples. As best shown in FIG. 14A, the intensities of the particles within each reference sample 200 . . . 208 vary. The y-axis shows the number of particles and the x-axis show the measured interior intensities. Each sample may typically contain several thousand particles that together form the distribution of the various intensities. The distributions of the particles in reference samples 200 . . . 208 are shown in both FIGS. 14-15. Preferably, the interior intensity of each particle is thus measured and the intensities of all the particles in each sample form the distributions. The peaks 244, 246, 248, 250 and 252 of the particle distributions, shown in FIG. 14B of a gaussian fitted to each reference sample 200 . . . 208 respectively are shown as black dots 244, 246, 248, 250 and 252 in FIGS. 15A and 15B. Or more precisely gaussian curves were fitted to the distributions and the peaks (center) and widths (sigma) of the gaussians are shown as the black and grey dots in FIGS. 15A and 15B.

It is important to normalize the images prior to measuring the intensities of each particle. Factors that might affect the intensity levels, range and homogeneity in electron microscopy images stem both from the instrument and from the sample. They are for example illumination and exposure settings, beam centering and alignment, thickness and homogeneity of the sample and ice embedding, the type of buffer, the time the microscope has been operating etc. These factors should be kept the same or as similar as possible when comparing samples, and the differences that remain are corrected (uneven background) and normalized to internal image reference levels (e.g., the average background intensity and the average particle shell intensity. By careful corrections and normalization, the comparison of the measured intensities is more accurate (so that the measured interior intensities are not affected by differences in, for example, the background or illumination). Preferably, the measurements of the particle interior intensities are not done immediately adjacent to the shell of the particles but closer to the center of the particle. When the shade of the background is determined it is preferably that a segment immediate outside each particle is not included in the calculations. The particles are expanded to make sure only pixels from the background not affected by the bright defocus ring surrounding each particle are used in the calculations of the background shade. It is possible to alternatively use empty particles when normalizing the intensities of the images.

FIG. 16A is a schematic view of an image of the first reference sample 200 with uneven background intensity 300 and three particles 210, 212 and 214 packed with a genetic material 302 that has first size. The bright defocus ring 125 surrounding each particle is also illustrated for the particles in FIG. 16A. FIG. 16B is a schematic view of the first reference sample 200 (the same view as FIG. 16A) but where the uneven background 300 has been corrected to a corrected background 304 so the whole background has the same intensity level.

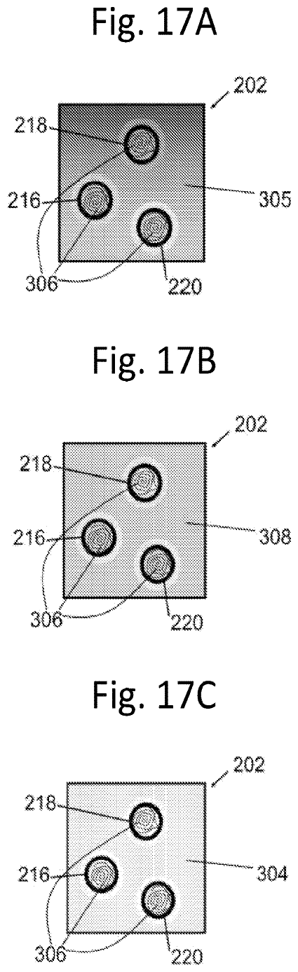

FIG. 17A is a schematic view of an image of a second reference sample 202 with an uneven background intensity 305 and three particles 216, 218, 220 are packed with a genetic material 306 of a second size that is smaller than that of genetic material 302 of the first reference sample 200 shown in FIGS. 16A-16B.

FIG. 17B is a schematic view of the second reference sample 202 that is the same view as illustrated in FIG. 17A but where the uneven background 305 has been corrected to a corrected background 308 so the whole background has a same intensity level. FIG. 17C is a schematic view of an image of the second reference sample 202 that is the same as FIG. 17B but illustrating that the intensities have been normalized (to those in FIG. 16B) so that the mean background intensities in FIG. 17C and FIG. 16B are the same (304) as are the mean intensity levels of the particle shells.

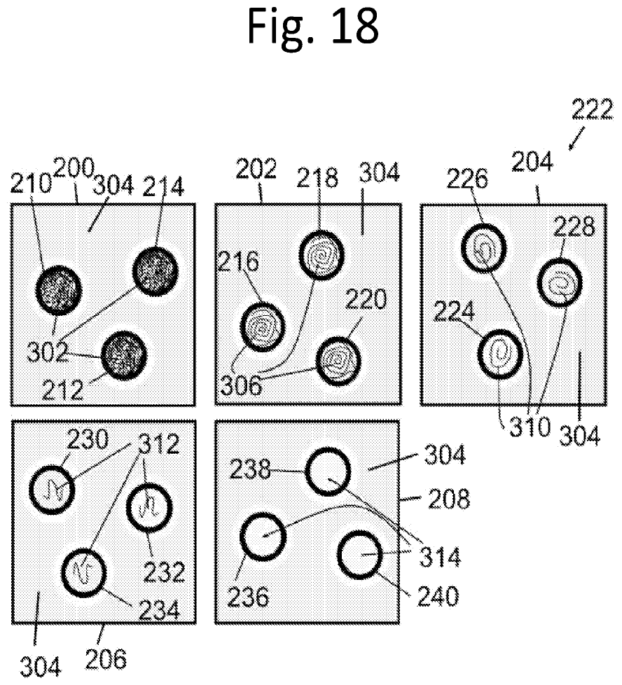

FIG. 18 is a schematic view 222 of the five reference samples 200, 202, 204, 206 and 208, each reference sample has three particles packed with genetic material of different sizes for each sample. The first reference sample 200 has virus or virus-like particles 210, 212 and 214 each including the first genetic material 302. The second reference sample 202 has virus or virus-like particles 216, 218 and 220 each including the second genetic material 306. The third reference sample 204 has virus or virus-like particles 224, 226 and 228 each including the third genetic material 310. The fourth reference sample 206 has virus or virus-like particles 230, 232 and 234 each including the fourth genetic material 312. Finally, the fifth reference sample 208 has virus or virus-like particles 236, 238 and 240 each carrying no genetic material so the interior 314 is empty. Each image has been corrected for uneven background and intensity normalized so all five images have the same average background intensity 304 and average particle shell intensity.

### Example

Below is an example of how CryoTEM is used to apply the method of the present invention. The present invention is not limited to CryoTEM and other microscopy methods may be used.

### Grid Preparation

Suitable grids, such as 400 mesh copper (Cu) grids, were first hydrophilized. This was done by glow-discharging the grids. More particularly, the copper grids, covered with a carbon film, were placed in a glow discharger. Vacuum was applied until the pressure reached about 0.5 mbar in the chamber. A current was applied, such as about 20 mA, for about 1 minute. The pressure was then increased to ambient pressure. The grids were removed, and the glow-discharger was turned off.

### Grid Freezing

A plunge freezer was turned on. The sample chamber was equilibrated to the desired temperature and humidity. The blot paper in the sample chamber was changed. An ethane bath in the cooling station was prepared. A freshly glow-discharged grid was loaded on the tweezers. The freezing process was started. About 3 μL of the sample was deposited on a grid. After about 10 seconds of wait time, the grid was blot with filter paper and plunge frozen. The grid was transferred in a cryo-grid box and stored in liquid nitrogen. The ethane and liquid nitrogen were safely thawed, and the plunge-freezer was turned off.

### Grid Transfer

The cryo-grid box was transferred from its storage location into a cryo-work station precooled with liquid nitrogen and the grid was clipped into a cartridge, which was subsequently loaded into an autoloader cassette. The autoloader cassette was inserted into the CryoTEM under cryogenic conditions.

### Imaging

In the imaging step, it was important to make sure the microscope had been correctly aligned according to the protocol described by the manufacturer, and that the blank image from the camera was flat. (It is to be understood that the imaging step may be done automatically where images are acquired automatically without requiring an operator to be sitting at the microscope to acquire the images. The grid is screened until finding a suitable area.) The magnification was then set with a field of view of about 600-1500 nm.

The focus 0 was found before setting the microscope at a slight defocus of about 7 μm. This defocusing step could have been done manually or automatically in microscopes that have autofocus and defocus functionality. The image was acquired and moved to a nearby area. The step of acquiring the image was be repeated until the desired number of images was acquired.

### Subsequent Image Treatment and Analysis

The images were saved and imported by suitable analysis software such as Vironova Analyzer Software (VAS). The images to be saved in the microscope were selected and saved in a suitable format such as in a 16 bit tiff format or alternatively automatically saved after the automatic image acquisition. A folder corresponding to the project in VAS was created and all the required information in the different nodes was completed. The images were imported in the “Microscopy” node by right clicking on the node, selecting “Open image(s)” and choosing the appropriate files prior to clicking on “Open”.

### Illumination Correction and Particle Detection

Prior to applying illumination correction, a small median filter was applied to the images to remove shot noise.

Illumination correction was then performed by subtracting a background image derived by applying a large gaussian filter (radius 200 nm) to the image.

Next, in the “Microscopy” node, in the “Particle Type” field, the “VLP (cryo)” was entered. The images in which particles were to be detected were selected before right-clicking on one of them. A “Run detection . . . ” was chosen. The following parameters were entered:

Ellipse segmentation

| Detection algorithm | Recommended | Acceptable |
|---|---|---|
| Parameter | Nominal Value | Range |
| Clear Content of Detected | Yes | Yes |
| Particle | | |
| Dark membranes | Yes | Yes |
| Divide Large Components | Yes | Yes |
| Edge Gap Tolerance | 0.2 | 0.2 |
| Edge Width (nm) | 5 | 4-6 |
| Maximum Diameter (nm) | 24 | 22-30 |
| Minimum Diameter (nm) | 18 | 16-22 |
| Minor Axis Ratio | 0.2 | 0.2 |
| Output shape | Circular | Circular |
| Post Processing Refinement | Yes | Yes |
| Prefer Circular Ellipses | Yes | Yes |
| Pre-processing method | EdgeDetection | EdgeDetection |

The detected particles were displayed on the Plot Control by using the scatterplot display, with “Size” on the x axis, and “Signal-To-Noise” on the y axis. The detected particles with a signal to noise<0.1 were first selected before deleting them.

The detected particles, with a size<17 nm and >28 nm, were then selected before deleting them also. The images were screened and falsely and incorrectly detected AAV particles were removed. The correctly detected particles were accepted by using the verify tool. The AAV particles that were not detected by the automated detection were manually boxed.

In more general terms, the following analysis steps were performed:
1) The particles of interest were detected either manually or by using a suitable detection algorithm (for example, template matching, circular object detection, region or border-based detection methods etc.);
2) False detections based on size, shape and the signal to noise ratio for each particle were removed (automatically or manually or a combination of both); and
3) If necessary, particles that were not detected were added if an automated detection algorithm was used.

### Intensity Normalization and Determination of Particle Internal Intensity Distribution

For each image, the intensity was normalized to a fixed range by linearly stretching the intensity values in the illumination corrected image so that the 20th percentile of the particle shell masks corresponds to value A (dark) and the median of the background mask correspond to value B (bright).

In the particle class node of the Plot control toolbar, “Content” was chosen. The internal intensities of the detected particles were displayed as a histogram. A gaussian was fitted to the histogram and the intensity at the peak of the gaussian was translated to the length of the cargo genome via the established linear relationship.

While the present invention has been described in accordance with preferred compositions and embodiments, it is to be understood that certain substitutions and alterations may be made thereto without departing from the spirit and scope of the following claims.

What is claimed is:

1. A method for establishing a correlation between measured interior intensities of the particles using electron microscopy and the size of the genetic materials contained in virus or virus-like particles (VLPs), comprising:
a) providing a first reference sample (200) of virus or virus-like particles (VLPs) (210, 212, 214) containing a first genetic material (302) having a known first size, a second reference sample (202) of virus or virus-like particles (VLPs) (216, 218, 220) containing a second genetic material (306) having a known second size, a third reference sample (204) of virus or virus-like particles (VLP) (222, 224, 226) containing a third genetic material (308) having a known third size, the first size being different from the second size and the second size being different from the third size;
b) imaging the first, second and third samples (200, 202, 204) using a hydrated state imaging technique;
c) measuring a particle interior intensity of each virus particle or VLP in images of each reference sample (200, 202, 204);
d) determining a distribution of particle interior intensities of the virus particles or VLPs in each reference sample (200, 202, 204);
e) fitting a curve to the distribution of the first, second and third reference samples (200, 202, 204), correlating the measured interior intensities to each respective known first, second and third size;
f) the fitted curve describing a relation between the interior particle intensities and the first, second and third sizes of the first, second and third genetic materials, respectively; and determining the size of an unknown genetic material of a sample of an unknown virus or VLP by measuring a particle interior intensity of the genetic material of the unknown sample by applying the measured particle interior intensity on the curve to find the size of the genetic material that corresponds to the measured particle interior intensity of the unknown sample;
g) wherein the measured particle interior intensities are normalized locally based on each particle's shell intensity and an intensity of the local background surrounding the particle excluding a closest background region corresponding to a bright defocus ring.

2. The method according to claim 1 wherein the method further comprises connecting two or all three of the first, second and third distributions to form a straight line (242).

3. The method according to claim 1 wherein the established correlation is used to determine a genome length of a sample with a cargo of genetic material of unknown length.

4. The method according to claim 1 wherein the method further comprises the step of graphically displaying the distribution of the particle interior intensities for each reference sample relative to sizes of the genetic material in each reference sample.

5. The method according to claim 1 wherein the method further comprises the step of estimating a peak of the histogram for which a peak intensity (244, 246, 248, 250, 252) of each reference sample represents a most common interior intensity value of particles in each reference sample and connecting the displayed distributions of each reference sample, based on the peak intensities of each reference sample (200, 202, 204), as a straight line (242).

6. The method according to claim 1 wherein the method further comprises the step of taking images of the reference samples and normalizing the images.

7. The method according to claim 6 wherein the method further comprises the step of normalizing background and particle shell shade.

8. The method according to claim 7 wherein an average intensity of background pixels and an average intensity of particle shell pixels in an image corrected for uneven background are used as reference values for the normalization.

9. (canceled)

10. The method according to claim 1 wherein the method further comprises the step of measuring particle interior intensities of adeno associated virus (AAV) particles.

11. The method according to claim 1 wherein the hydrated state imaging technique used is cryoTEM comprising of freezing and imaging the samples at a cryogenic temperature.

12. The method according to claim 1 wherein the hydrated state imaging technique used comprises adding an ionic liquid to the sample to keep the particle in a hydrated state followed by room temperature TEM.

13. The method according to claim 1 wherein the hydrated state imaging technique used comprises using a liquid sample holder to keep the samples in liquid form and imaging the samples in room temperature TEM.

14. The method according to claim 1 wherein the method further comprises the step of measuring particle interior intensities of bacteriophages.

15. The method according to claim 1 wherein the method further comprises the step of particle interior intensities of AAV particles of different serotypes.

16. The method according to claim 1 wherein the method further comprises the step of quantitatively describing, separating and classifying particle populations based on internal intensities.
